(19) United States
(12) Patent Application Publication
(10) Pub. No.: US 2002/0026324 A1
(43) Pub. Date: Feb. 28, 2002

(54) Computer peripheral sales promoting system and method thereof

(75) Inventor: Akihiko Okada, Tokyo (JP)

Correspondence Address: SUGHRUE, MION, ZINN, MACPEAK, SEAS, 2100 Pennsylvania Avenue, N.W., Washington, DC, 20037-3202, US

(73) Assignee: NEC CORPORATION

(21) Appl. No.: 09/928,451

(22) Filed: Aug. 14, 2001

(30) Foreign Application Priority Data
Aug. 24, 2000 (JP) 2000-253506

(51) Int. Cl. G06F 17/60

(52) U.S. Cl. 705/1

(57) ABSTRACT

A service status detecting component for detecting a service status of a computer peripheral and a customer product information storing means for updating and storing the specifications information and the service status of this computer peripheral are provided in the computer peripheral or a computer which acts as an upper-level system of this computer peripheral. In such a configuration, sales promoting terminals 10-30 for making access to the customer product information storing means to thereby read out the specifications information and the service status are arranged in a network to which that computer peripheral or the computer is connected. This permits a sales person to confirm at the sales promoting terminals 10-30 the specifications information and the service status of a sold computer peripheral and then compare those information items to each other and discuss them to thereby suggest a purchase plan for expansion, upgrading, functional extension of the apparatus, thus carrying out streamlined business operations without waste of labor.

### BACKGROUND OF THE INVENTION

1. Field of the Invention

The present invention relates to an improvement in computer peripheral sales promoting system and method thereof.

2. Description of the Related Art

Conventionally, to sell a computer peripheral, a sales person has usually visited companies or offices which use a computer one by one to consult them as for a configuration of a system as a whole and its model to be selected, thus acquiring them as a customer. Also, in order to keep a business relationship with such customers after they bought a computer peripheral, the sales person must visit them appropriately periodically to know about how they are utilizing the peripheral.

Although, as mentioned above, the sales person must visit his customers one by one to know their operational trend, if some of the customers have introduced a high-spec computer peripheral, they may not need to introduce a new model or expand or upgrade their existing model for a long time after the purchase to thereby often make it difficult to conclude new negotiations, resulting in waste in labor.

Conversely, there are some cases where a customer may need to introduce a new mode of computer peripheral or expand or upgrade his existing model in emergency, in which cases, however, if the customer is not usually familiar with the sales person, he often cannot know about the current utilization state of the relevant computer peripheral, thus possibly leading to such a problem that a required peripheral or components may not be supplied in time for the customer when he came up with a plan for introducing a new model required or expanding or upgrading the existing model.

### SUMMARY OF THE INVENTION

In view of the above, it is an object of the present invention to provide computer peripheral sales promoting system and method thereof that can solve the prior art disadvantages and make it possible to always and accurately know about the utilization status of a customer's computer peripheral easily, thus providing streamlined business activities.

To achieve the above-mentioned object, the present invention comprises such a configuration that provides both a service status detecting means for detecting the service status of a computer peripheral and a customer product information storing means for storing specifications information of the above-mentioned computer peripheral as well as user information for specifying a user of the above-mentioned computer peripheral and also for consecutively updating and storing the service status detected by the above-mentioned service status detecting means to an upper-level system computer of the above-mentioned peripheral and also that provides a network to which the above-mentioned computer is connected with a sales promoting terminal for accessing the above-mentioned customer product information storing means to read the above-mentioned specifications information and service status.

By this configuration, the sales person can easily confirm through the sales promoting terminal and the network the specifications information, the user information, and the service status of a computer peripheral he sold to them, without taking trouble of visiting each of his customers.

Also, the sales person can compare in discussion the above-mentioned specifications information and service status to each other to thereby suggest a purchase plan to each of his users for expansion, upgrading, or functional extension of their computer peripheral, thus streamlining his business activities with no waste in labor.

Further, the sales person can know about the service status of the customer's computer peripheral beforehand to thereby anticipate his demands and so prepare in advance such products or components as required for the expansion, upgrading, or functional extension, thus rapidly accommodating his requirements.

Also, he may provide the service status detecting means and the customer product information storing means to a peripheral itself rather than to its upper-level system computer.

Besides the above-mentioned ease in confirming of the specifications information, user information, and service status of a computer peripheral he sold to his customer, he can streamline his business activities without waste in labor and rapidly accommodate his customer's demands.

Further, preferably, an upper-level computer of a computer peripheral or a network to which the computer peripheral itself is connected is constituted by the internet.

The relevant network can be constituted by the internet covering a wide areas to thereby eliminate the restrictions on a location where a sales promoting terminal can be installed for confirming the specifications information, user information, and service status of a computer peripheral he sold to his customer, thus permitting him to freely carry out streamlined business activities over a wide area.

For example, a data storing apparatus is suitable as a computer peripheral to which this sales promoting system may be applied.

A data storing apparatus, for example, has a predetermined disk capacity, so that timing for its expansion, upgrading, functional extension can be accurately predicted by confirming the specifications information and service status of that apparatus and also various jobs can be easily carried out including suggestion and anticipated preparation of products and components required for the next time expansion, upgrading, or functional extension.

To apply this sales promoting system to a data storing apparatus, the specifications information must include at least its disk capacity and the service status detecting means must be provided with a function for detecting a spent disk capacity and a load status of the data storing apparatus.

By comparing the disk capacity and a spent disk capacity of the data storing apparatus to each other, timing can be easily predicted for expansion, upgrading, functional extension of that apparatus. Also, by detecting the load status of the data storing apparatus, it is possible to suggest an appropriate data storing apparatus which can meet the user's demands when he wants to expand, upgrade or functionally extend his existing apparatus.

### BRIEF DESCRIPTION OF THE DRAWINGS

FIG. 1 is a block diagram for showing one embodiment where a sales promoting system according to the present invention for a computer peripheral is applied to a sales promoting system;

FIG. 2 is a flowchart for showing one example of processing by a service status detecting means for detecting a load status of a sold data storing apparatus;

FIG. 3 is a flowchart for showing an outline of processing by the service status detecting means of overwriting service status information of the sold data storing apparatus in a customer product information storing means;

FIG. 4 is a flowchart for showing an outline of processing for transferring the customer product information of the data storing apparatus to an information terminal server;

FIG. 5 is a flowchart for showing an outline of processing carried out by the sales promoting terminal used by a sales person; and

FIG. 6 is a flowchart for showing an outline of processing carried out at a manufacturing point terminal.

### DESCRIPTION OF THE PREFERRED EMBODIMENTS

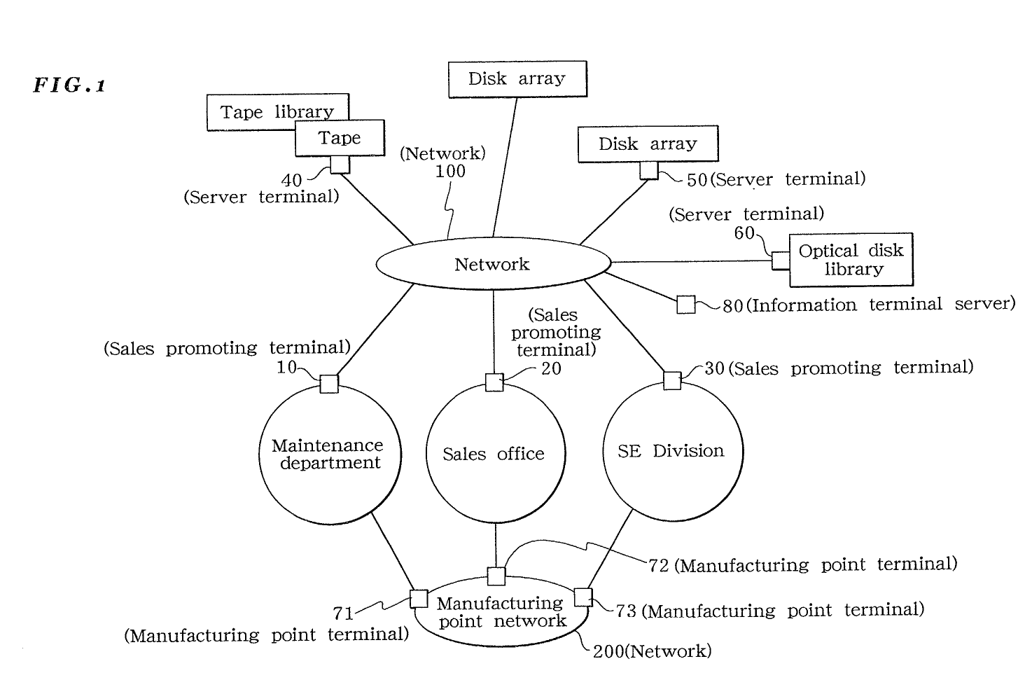

The following will describe embodiments of the present invention with reference to the drawings. FIG. 1 is a block diagram for showing one embodiment in which a sales promoting system according to the present invention for a computer peripheral is applied to a data storing apparatus, which is one type of computer peripheral.

This system roughly comprises sales promoting terminals 10-30 provided to a maintenance department, a sales office, and an SE (service engineering) department respectively, server terminals 40-60, manufacturing point terminals 71-73, and networks 100 and 200 for interconnecting them respectively.

The sales promoting terminals 10-30 and the manufacturing point terminals 71-73 are all an information processing apparatus such as a personal computer. The server terminals 40-60 and an information terminal server 80 are each constituted by, not to say of a personal computer, such an information processing apparatus as a workstation. The sales promoting terminals 10-30 have a function for making access to customer product information of a sold data storing apparatus such as a tape library, a disk array, and an optical DISK library and then displaying this customer product information on a screen.

The customer product information is roughly divided into specifications information, user information, and service status information.

The specifications information of these two kinds of information comprises data relating to a device configuration of the sold data storing apparatus, disk capacity (at the time of sales), cache capacity, software, etc. and fixed data relating to a product name, model number, product number, sales date, price, etc., while the user information comprises data used for specifying a user who bought this data storing apparatus, i.e. fixed user ID data also. The service status information comprises data of a spent disk capacity, load status, etc., i.e. data changing with a changing service status of the data storing apparatus.

The customer product information storing means for storing customer product information can be provided to a nonvolatile memory etc. of the server terminals 40-60, which are an upper-level device to which is connected the sold data storing apparatus such as a tape library, disk array, or optical DISK library. Also, software serving as the service status detecting means for detecting a service status of those computer peripherals is installed to the server terminals 40-60 to thereby consecutively detect the data such as a spent disk capacity, a load status, etc. of the sold data storing apparatus and consecutively overwrite it in the above-mentioned customer product information storing means.

Also, the sales promoting terminals 10-30 have a function for enabling the sales person who operates these terminals 10-30 to confirm the specifications information, the service status information, etc. of the sold data storing apparatus to then transmit via the network 200 to the manufacturing point terminals 71-73 the product information (purchase order information) of a product he advises his customer to buy and the retail store specifying information indicating a retail store where that product is to be received by the customer.

The manufacturing point terminals 71-73 have a function of receiving the purchase order information and the retail store specifying information sent by the sales promoting terminals 10-30 based on the operation of the sales person and the generating order maker identifying information including existence/nonexistence of stocks, a delivery time, etc. and then transmitting it to the sales promoting terminals 10-30.

Then, having received acknowledgement from the customer finally, the sales person expands the capacity or improves the performance locally or delivers a product to the customer to then a payment process is performed.

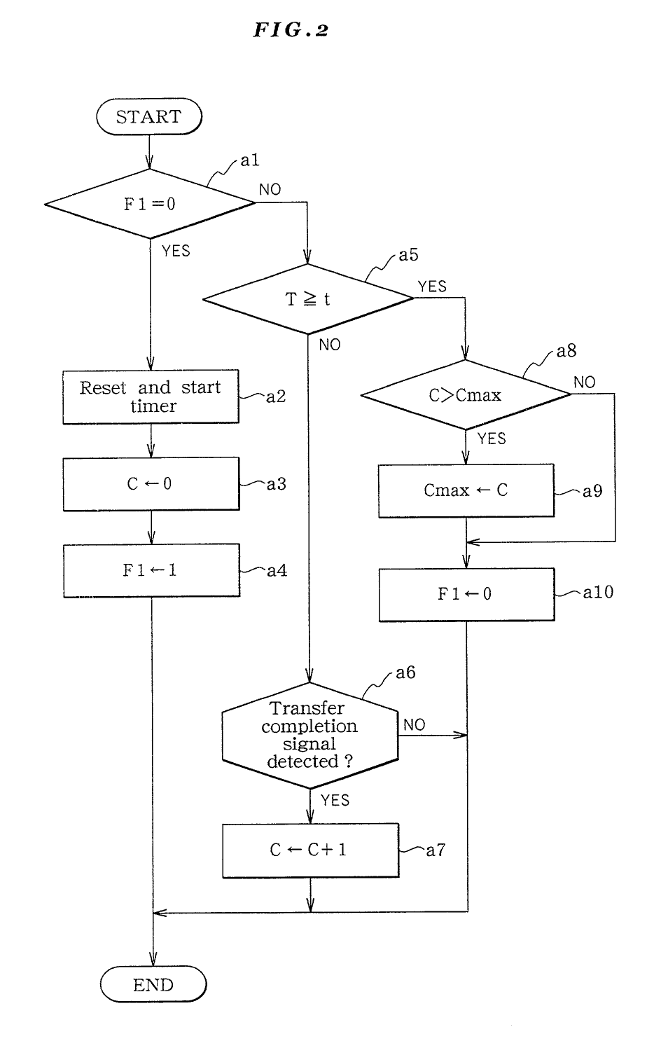

The following will specifically describe the essential operations of the software constituting the service status detecting means, the nonvolatile memory serving as the customer product information storing means, the sales promoting terminal, and other main components with reference to FIGS. 2-6. The network 100 usually may be comprised of the internet, while the network 200 may be the internet or an intranet of a company.

FIG. 2 is a flowchart for showing one example of processing by the service status detecting means constituted by the software installed to the server terminals 40-60 for detecting a load status of the sold data storing apparatus, which processing is executed repeatedly for each predetermined period by the CPU of the server terminals 40-60.

The CPU of the server terminals 40-60 first decides whether an measurement flag F1 is set (step al) and comes up with a decision result of TRUE at step al because that flag F1 is reset in the initial state, so that the CPU of the server terminals 40-60 first reset the count value of a timer T for measuring an elapsed time and then restarts it (step a2), resets the count value of a counter C (step a3), and sets the measurement flag F1 (step a4), thus terminating this period of processing.

Since the measurement flag F1 is already set, in the next period of processing, the decision result at step a1 is FALSE, so that the CPU of the server terminals 40-60 decides whether the time measured by the timer T has reached a set value t (step a5). If the measured time at the timer T has not reached the set value t, the CPU of the server terminals 40-60 decides whether a transfer completion signal has been output from a sold data storing apparatus such as a tape library, disk array, or optical DISK library, i.e. the data storing apparatus connected to those server terminals 40-60 (step a6) and, only if the transfer completion signal has been output, increments the count value of the counter C.

Note here that the transfer completion signal is output when data is completely transferred and written from the server terminals 40-60 to the data storing apparatus.

Afterward, until the measured time at the timer T reaches the set value t, the server terminals 40-60 execute the above-mentioned processing repeatedly to thereby record the number of times the transfer completion signal has been detected during this predetermined time lapse t in the counter C.

When it is decided at step a5 that the measured time at the timer T has reached the set value t, the CPU of the server terminals 40-60 decides whether the number of times the transfer completion signal has been detected during the predetermined time lapse t, i.e. the count value of the counter C is larger than the value of a maximum value storing register (which has an initial value of 0) (step a8) and, only if the count value of the counter C is larger than the value of the maximum value storing register (which has an initial value of 0 upon power application), stores that value of the counter C in the maximum value storing register (step a9) and resets the measurement flag F1 (step a10), thus terminating this period of processing.

The above-mentioned processing is repeated to resultantly store the maximum number of writing times for the unit time lapse t in that day in the maximum value storing register. This maximum number of writing times Cmax is a kind of value representing a load on the data storing apparatus and so can be utilized as the service status information of that apparatus.

Of course, the value representing the load on the data storing apparatus is not limited to the maximum number of writing times Cmax; for example, an average value of the number of writing times for each unit time lapse obtained from the number of data writing times for one day.

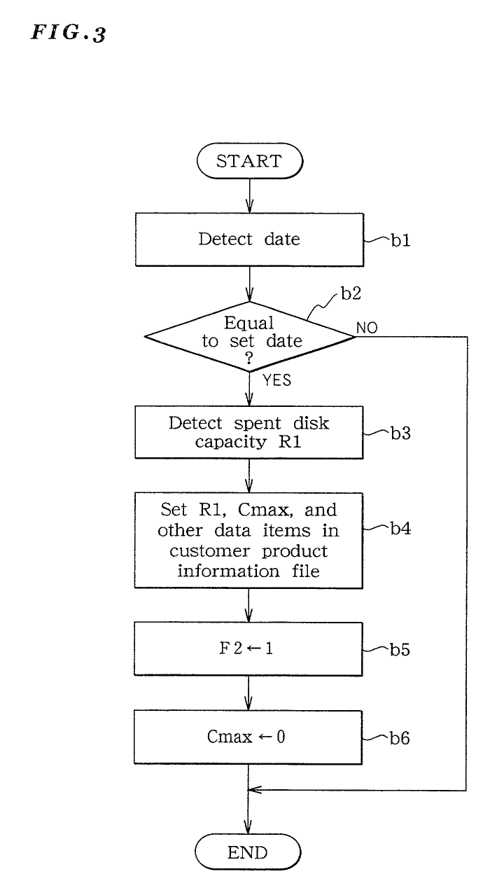

FIG. 3 is a flowchart for showing an outline of processing by the service status detecting means for updating the service status information of the sold data storing apparatus and storing it in the customer product information storing means, which processing is executed during, e.g. initialization upon activation of the server terminals 40-60.

The CPU of the server terminals 40-60 first utilizes its own clock function to detect the current date (step b1) and decides whether this data agrees with a set date in which the data of the customer product information storing means is to be updated (step b2). This set date can be specified as an interval of once a few days, a specific date of the month or a specific day of the week, etc arbitrarily.

If that current date agrees with the set date, the CPU of the server terminals 40-60 serving also as the service status detecting means reads in a spent disk capacity value R1 at the current time from a volume information storing portion of the data storing apparatus (step b3) and overwrites this value of the spent disk capacity R1 and the value of the maximum number of writing times Cmax in a customer product information file as the service status information (step b4). In this case, the data relating to the device configuration, disk capacity (at the time of sales), cache capacity, software, etc. of the data storing apparatus, the specifications information relating to the product name, model number, product number, sales date/time, prices, etc., and the user information are read in from the nonvolatile memory and stored in the above-mentioned customer product information file. The customer product information file itself can be located in the above-mentioned nonvolatile memory or data storing apparatus.

Subsequently, the CPU of the server terminals 40-60 sets a transfer waiting flag F2 to thereby store data to be transferred from any one of these servers to the information terminal server 80 (step b5) and resets the value of the maximum value storing register (step b6), thus terminating the processing related to the updating of the service status information.

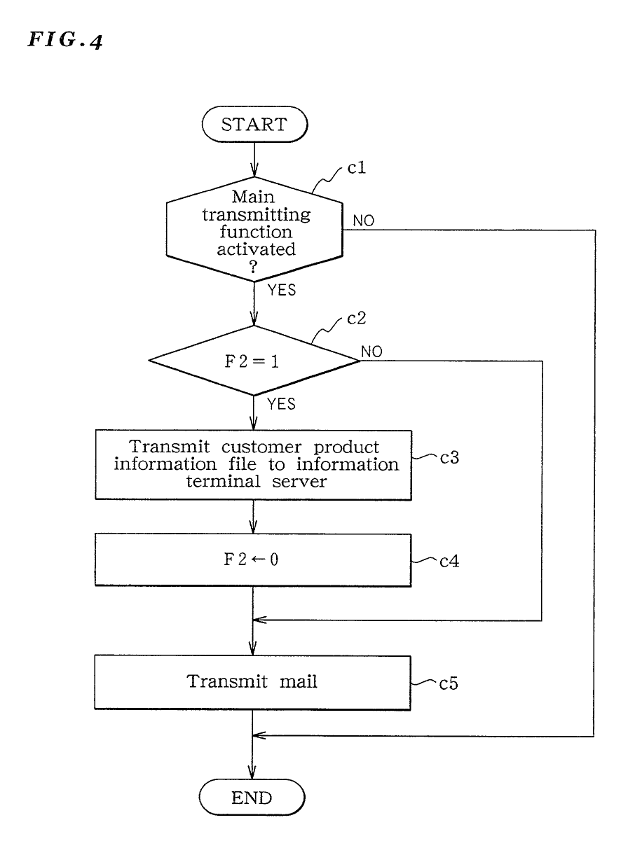

FIG. 4 is a flowchart for showing an outline of processing for transferring to the information terminal server 80 the customer product information file storing the customer product information of the data storing apparatus connected to the server terminals 40-60. This processing is automatically executed properly when a customer transmits his mail to the outside over the network 100 in order to avoid inflicting an excessive load on the server terminals 40-60 when any one of them is being used by the customer.

Having detected the activation of the mail transmitting function by the customer (step c1), the CPU of the server terminals 40-60 first decides whether the transfer waiting flag F2 is set, i.e. whether new data to be transferred to the information terminal server 80 is set in the customer product information file (step c2).

When it is confirmed that the transfer waiting flag F2 is set and there is present some data to be transferred to the information terminal server 80, the CPU of the server terminals 40-60 transmits the customer product information of the data storing apparatus connected to the server terminals 40-60, i.e. a customer product information file storing the specifications information of the data storing apparatus, the user information, and the service status information, to the information terminal server 80 (step c3) and then resets the transfer waiting flag F2 (step c4) to thereby send a transmit mail desired to be done so by the user to a transmission destination mail address according to the similar conventional procedure (step c5).

If the transfer waiting flag F2 is not set, on the other hand, the processing of the steps c3 through c4 is not executed, so that the transmit mail desired by the user is only sent as usual.

The above-mentioned processing is repeated for each set date to resultantly transmit for each set date the customer product information of the data storing apparatus connected to the server terminals 40-60, i.e. the specifications information of the data storing apparatus, the user information, and the service status information, which is variable data, to the information terminal server 80.

The information terminal server 80, when having received such information, sorts the customer product information for each user in an elapsing order of the date based on the reception date of the customer product information file and the user information.

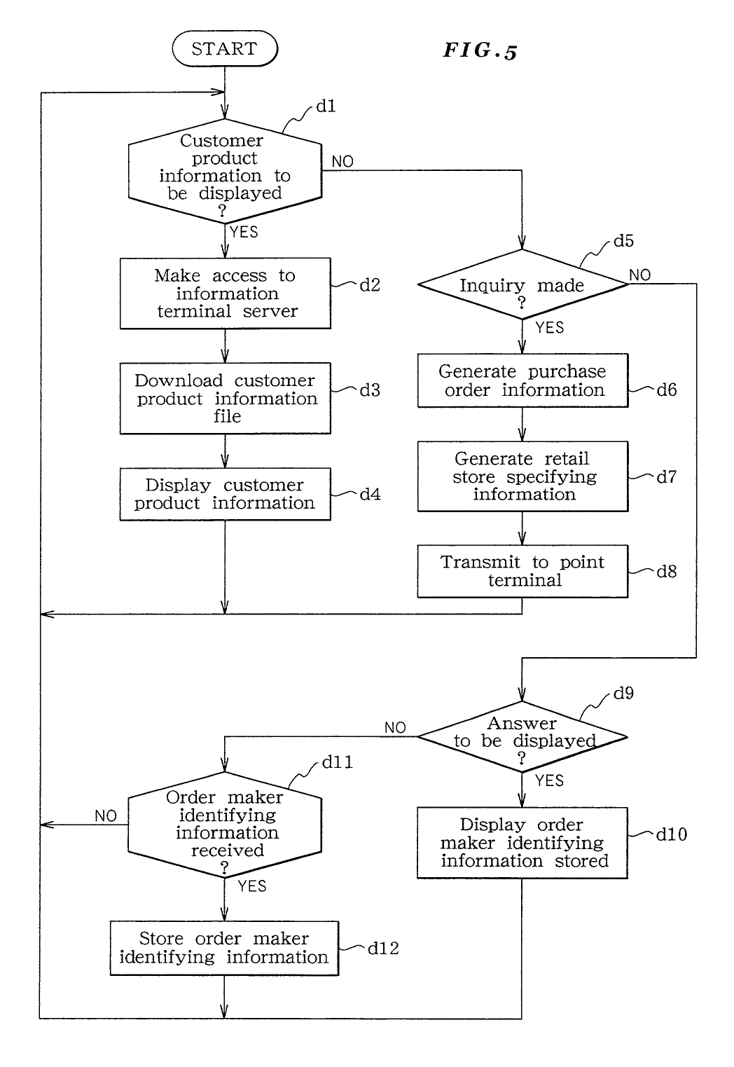

FIG. 5 is a flowchart for showing an outline of processing executed by the sales promoting terminals 10-30 used by the sales person at the maintenance department, the sales office, or the SE (Service Engineering) department.

The CPU of the sales promoting terminals 10-30 responds to an operation of, e.g. a function key or a GUI (Graphic User Interface) which constitutes a man-machine interface to then make access to the information terminal server 80 in order to display the customer product information file (step d1), make an inquiry to the manufacturing point terminals 71-73 about stocks or delivery time of products (step d5), and display answers sent from the manufacturing point terminals 71-73 (step d9). Also, the CPU utilizes all-time connection with the network 200 to monitor transmission/non-transmission from the manufacturing point terminals 71-73 (step d11), thus executing the processing relating to receiving and saving of the data transmitted from the manufacturing point terminals 71-73, i.e. the order maker identifying information which constitutes the answer to the inquiry.

Specifically, when the sales person operates the sales promoting terminals 10-30 to thereby make a request for displaying the customer product information file (step d1), the CPU of the sales promoting terminals 10-30 first makes access to the information terminal server 80 via the network 100 (step d2) to then reference the user information such as the user ID specified by the sales person and then download a customer product information file of the corresponding user (step d3), thus displaying the information on a monitor screen (step d4).

As mentioned above, the customer product information files are sorted for each user in the date order by the information terminal server 80. Also, the specifications relating to a device configuration, disk capacity, cache capacity, software, product name, model number, product number, sales date/time, prices, etc. and the actual service status relating to a spent disk capacity, load status, etc. are clearly described in the customer information file, so that the sales person can compare in discussion time-series changes in the spent disk capacity, load status, etc. to the specifications of the disk capacity, cache capacity, etc., thus suggesting to each of his customers an appropriate purchase plan for expansion, upgrading, functional extension, etc. of the data storing apparatus.

If, for example, the spent disk capacity is increasing drastically and is anticipated to consume all of the disk capacity in a few days, the data storing apparatus may need memory expansion or upgrading and, if the load is increasing, the system may need cache expansion or replacement with a high-speed data storing apparatus or, if the software (drivers and other firmware) is old fashioned, it may need software updating.

Although the sales person takes such various statuses into consideration to thereby suggest to each of his customers a purchase plan for expansion, upgrading, functional extension, etc. of the data storing apparatus, if the system may need expansion or replacement of the existing data storing apparatus or cache expansion in a few days, there may be such a case where it is better if he confirms existence/nonexistence of stocks of the desired product before making a suggestion to his customers.

In such a case, the sales person can operate the sales promoting terminals 10-30 to make an inquiry to the manufacturing point terminals 71-73 for stocks and delivery time of the product.

When the sales person operates the sales promoting terminals 10-30 to enter a request for inquiry (step d5), the CPU of the sales promoting terminals 10-30 generates purchase order information which specifies a product desired to be purchased according to specifications given by the sales person (step d6) and also generates retail store specifying information which specifies a place where the product is to be received according to a desired place specified by the sales person (step d7) and then transmits such information via the network 200 to the manufacturing point terminals 71-73 (step d8).

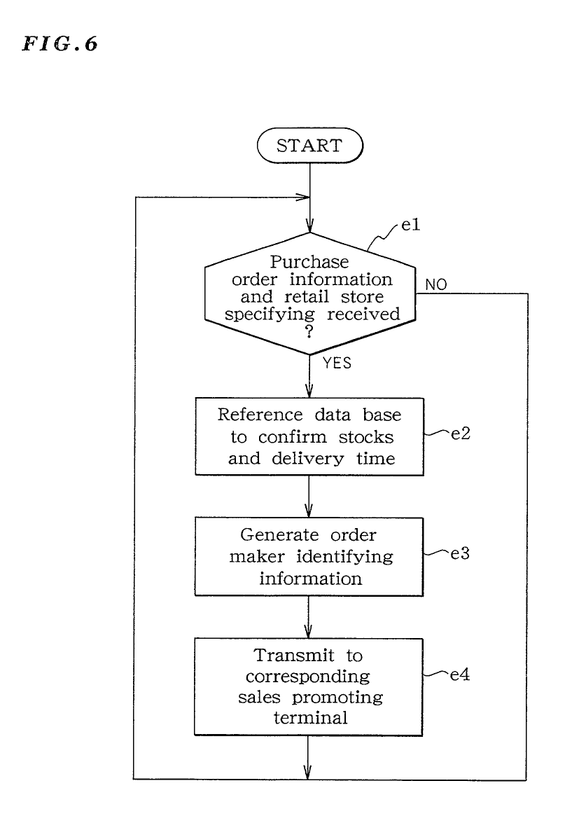

The CPU of the manufacturing point terminals 71-73 in all-time connection with the network 200, on the other hand, is repeatedly executing such processing as shown in FIG. 6, to detect by decision made at step el the purchase order information and the retail store specifying information transmitted from the sales promoting terminals 10-30.

Having detected the transfer of the purchase order information and the retail store specifying information, the CPU of the manufacturing point terminals 71-73 references its own database of products and retail stores to thereby and confirm existence/nonexistence and delivery time of the products desired to be purchased at a retail store corresponding to a desired delivery place (step e2) and, based on such information, generate order maker identifying information including as data at least the name of a retail store where a desired product can be delivered and a delivery time of the product (step e3), and then transmit this order maker identifying information to the corresponding sales promoting terminals 10-30 (which earlier transmitted the purchase order information and the retail store identifying information) (step e4).

This order maker identifying information is detected by the sales promoting terminals 10-30 at decision made at step d11 in FIG. 5, the CPU of which terminals 10-30 then saves this newly received order maker identifying information in the order maker identifying information file (step d12).

If, in this case, requested to display an answer by the operation of the sales person, the CPU of the sales promoting terminals 10-30 detects this request at decision made at step d9 to then display a list of the data stored in the order maker identifying information file (step d10). This enables the sales person to easily know a delivery time of a product desired to be purchased and the name of a retail store which can deliver that product for which an inquiry was earlier made to the manufacturing point terminals 71-73.

Finally, the sales person communicates with his customer with fax or e-mail transmission, telephoning, or direct visiting to suggest to him a purchase plan for expansion, upgrading, functional extension, etc. of the data storing apparatus and, when it is accepted, visits the above-mentioned retail store to procure products required for the expansion, upgrading, functional extension, etc. and then turns to the customer to enter a step of carrying out the actual jobs of the expansion, upgrading, functional extension, etc.

Although the above-mentioned embodiment has been described in such a case where the software constituting the service status detecting means and the nonvolatile memory constituting the customer product information storing means are provided to the server terminals 40-60 to thereby collect the information of a plurality of data storing apparatuses to the information terminal server 80 so that that information may be confirmed by the sales promoting terminals 10-30, such a configuration may be employed that the service status detecting means and the customer product information storing means are provided to the data storing apparatus itself or that the customer product information is transferred not via the information terminal server 80 but directly from the data storing apparatus or the server terminals 40-60 to the manufacturing point terminals 71-73.

Also, a computer peripheral to which the sales promoting system according to the present invention may be applied can be utilized not only in the above-mentioned data storing apparatus (tape library, disk array, optical DISK library, etc) but also in a printer or a personal computer itself or even in a local area network configuration in an enterprise etc.

The service status detecting means can be constituted by an appropriate program to monitor at a printer the total number of printed paper sheets or the number of printed paper sheets for a unit time lapse or to detect the load on a personal computer or even to monitor the quantity of data distributed through a local area network in an enterprise to thereby know the latent demands of the customers like in the case of the above-mentioned data storing apparatus, thus effectively suggesting to them a plan for expansion, upgrading, functional extension, etc. of the apparatus or the provision to carry out streamlined business operations.

By computer peripheral sales promoting system and method thereof according to the present invention, for example, a sales person can easily confirm, without visiting each of his customers, the specifications information of a computer peripheral he sold and the user information as well as the service status of that peripheral at a sales promoting terminal, so that he can compare in discussion the specifications information of the computer peripheral to its service status to thereby and suggest to each of the users a purchase plan for expansion, upgrading, functional extension, etc. of that computer peripheral, thus carrying out streamlined business operations without waste.

Moreover, the sales person can know in anticipation the service status of a computer peripheral purchased by his customers, so that he can anticipate their demands to prepare beforehand those products and components required for the expansion, upgrading, functional extension, etc., thus accommodating their demands rapidly.

Also, the internet can be used as a network to which a computer peripheral itself or its upper-level system computer is connected to thereby cover extremely wide areas, thus carrying out streamlined business operations.

In the case of a data storing apparatus, in particular, its disk capacity is predetermined, so that by confirming the specifications information such as the disk capacity and the service status such as a spent disk capacity, a load status, etc., it is possible to accurately anticipate the timing for accommodating expansion, upgrading, functional extension, etc. of the apparatus, thus extremely properly suggesting to the customers a plan for the expansion, upgrading, functional extension, etc. to be carried out next time.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-253506 (Filed on Aug. 24^{th}, 2000) including specification, claims, drawings and summary are incorporated herein by reference in its entirety.

What is claimed is:

1. A computer peripheral sales promoting system comprising:
a service status detecting means for detecting a service status of a computer peripheral and customer product information storing means for storing specifications information of said computer peripheral and user information which specifies a user of said computer peripheral and also for consecutively updating and storing a service status detected by said service status detecting means are provided in a computer which serves as an upper-level system for said computer peripheral; and
a sales promoting terminal for making access to said customer product information storing means to thereby read out said specifications information, said user information, and service status is arranged in a network to which said computer peripheral is connected.

2. A computer peripheral sales promoting system comprising:
a service status detecting means for detecting a service status of a computer peripheral and customer product information storing means for storing specifications information of said computer peripheral and user information of a user of said computer peripheral and also for consecutively updating and storing a service status detected by said service status detecting means is provided to said computer peripheral; and
a sales promoting terminal for making access to said customer product information storing means to thereby read out said specifications information, said user information, and said service status is arranged in a network to which said computer peripheral is connected.

3. The computer peripheral sales promoting system according to claim 1, wherein said network is constituted by the internet.

4. The computer peripheral sales promoting system according to claim 2, wherein said network is constituted by the internet.

5. The computer peripheral sales promoting system according to claim 1, wherein said computer peripheral is constituted by a data storing apparatus.

6. The computer peripheral sales promoting system according to claim 2, wherein said computer peripheral is constituted by a data storing apparatus.

7. The computer peripheral sales promoting system according to claim 3, wherein said computer peripheral is constituted by a data storing apparatus.

8. The computer peripheral sales promoting system according to claim 4, wherein said computer peripheral is constituted by a data storing apparatus.

9. The computer peripheral sales promoting system according to claim 5, wherein:
said specifications information includes at least a disk capacity of said data storing apparatus; and said service status detecting means detects a spent disk capacity and a load status of said data storing apparatus as a service status.

10. The computer peripheral sales promoting system according to claim 6, wherein:
said specifications information includes at least a disk capacity of said data storing apparatus; and said service status detecting means detects a spent disk capacity and a load status of said data storing apparatus as a service status.

11. The computer peripheral sales promoting system according to claim 7, wherein:
said specifications information includes at least a disk capacity of said data storing apparatus; and said service status detecting means detects a spent disk capacity and a load status of said data storing apparatus as a service status.

12. The computer peripheral sales promoting system according to claim 8, wherein:
said specifications information includes at least a disk capacity of said data storing apparatus; and said service status detecting means detects a spent disk capacity and a load status of said data storing apparatus as a service status.

13. A computer peripheral sales promoting method comprising steps of:
monitoring a specifications information of a sold computer peripheral and a service status of said computer peripheral by a sales promoting terminal arranged in a network to which said computer peripheral or a computer which acts as an upper-level system of said computer peripheral is connected;
comparing and discussing said specifications information and service status based on an information obtained by operating said sales promoting terminal; and suggesting a purchase plan for expansion, upgrading, functional extension, etc. of said computer peripheral based on said user information.
